(19) United States
(12) Patent Application Publication
(10) Pub. No.: US 2026/0170154 A1
(43) Pub. Date: Jun. 18, 2026

(54) INFORMATION PROCESSING DEVICE, INFORMATION PROCESSING METHOD AND INFORMATION PROCESSING PROGRAM

(71) Applicant: NTT, INC., Tokyo (JP)

(72) Inventors: Ryota SATO, Musashino-shi, Tokyo (JP); Yoshiaki NAKAJIMA, Musashino-shi, Tokyo (JP); Hiroyoshi TAKIGUCHI, Musashino-shi, Tokyo (JP)

(73) Assignee: NTT, INC., Tokyo (JP)

(21) Appl. No.: 19/126,251

(22) PCT Filed: Nov. 14, 2022
(86) PCT No.: PCT/JP2022/042299

§ 371 Date: May 1, 2025

(51) Int. Cl. G06F 21/60; G06F 21/62

(52) U.S. Cl. CPC G06F 21/604; G06F 21/6218

(57) ABSTRACT

A visualization definition information generation unit receives an input of at least one of a procurement requirement, an operation requirement, and a security requirement necessary for an apparatus, and sets an index for evaluating a level of information disclosure for each constituent element included in the apparatus. An information acquisition unit acquires partial configuration information indicating partial constituent elements of the apparatus. A visualization level calculation unit determines the level of the information disclosure for each constituent element included in the apparatus based on the partial configuration information and the index set by the visualization definition information generation unit, and calculates the level of the information disclosure of the apparatus. A notification unit notifies of the level of the information disclosure of the apparatus calculated by the visualization level calculation unit.

### TECHNICAL FIELD

The present invention relates to an information processing apparatus, an information processing method, and an information processing program.

### BACKGROUND ART

As social and industrial digital transformation accelerates, the procurement and operation of apparatuses and systems included in information communication infrastructures have attracted attention. Hereinafter, the apparatuses and the systems are simply referred to as “apparatuses”. Hardware components and software components included in apparatuses are provided from various business operators that from a supply chain of the apparatuses. Therefore, it is difficult for users to obtain sufficient information for performing various operations such as management, monitoring, and inspection of the apparatuses and to cope with risks such as license confirmation and vulnerability countermeasures.

Accordingly, the business operators that form the supply chain of the apparatuses share system configuration information, and make endeavors to utilize the system configuration information for risk countermeasures. For example, examples of techniques for sharing configuration information include software bill of materials (SBOM) in which all software components included in a specific information apparatus are listed.

### CITATION LIST

### Non Patent Literature

[NPL 1] “The Minimum Elements For a Software Bill Of Materials [SBOM]”, [online], Jul. 12, 2021, The United States Department of Commerce, [retrieved on 20 Oct. 2022], Internet <URL:https://www.ntia.doc.gov/files/ntia/publications/sbom_min imum_elements_report.pdf>

### SUMMARY OF INVENTION

### Technical Problem

In known techniques, the configuration information of the apparatus from a provider to a user is provided on the assumption that each component is an open source or the like and the configuration is all disclosed. However, since the configuration information often includes confidential information of the provider such as unique contrivance in a system that provides the configuration information, it is difficult for the provider to provide all the configuration information due to concern of leakage of the confidential information. Since granularity of the configuration information required by the user and usage of the information are not known in advance, even when the configuration information is provided, the provider is highly likely to provide minimum configuration information.

On the other hand, in a present situation, there are few appropriate visualization scales required for the user in usages or application fields of an apparatus or a system, that is, appropriate indexes for evaluating whether the configuration information is disclosed to a level sufficient for the user to perform verification or the like. Therefore, the user cannot determine whether the disclosed configuration information is sufficient to cope with a risk. As a result, even if the configuration information is excessive, the user requests that all the configuration information be provided.

When all the configuration information is provided in response to this, the provider bears an increase in cost for generating, confirming and sharing the configuration information. The burden of the cost of the provider is transferred to the price of providing by the apparatus or the system, and there is concern of the cost increasing unnecessarily for the user.

The present invention has been devised to solve the above-described problems, and an object of the present invention is to facilitate provision of an appropriate apparatus according to usage of a user.

### Solution to Problem

In order to solve the above problem and to achieve the purpose, an index setting unit receives an input of at least one of a procurement requirement, an operation requirement, and a security requirement necessary for a predetermined apparatus and sets an index for evaluating a level of information disclosure for each constituent element included in the predetermined apparatus. An information acquisition unit acquires partial configuration information indicating partial constituent elements of the predetermined apparatus. A visualization level calculation unit determines the level of the information disclosure for each of the constituent elements based on the partial configuration information and the index set by the index setting unit and calculates the level of the information disclosure of the predetermined apparatus based on a determination result and based on the level of the information disclosure for each of the constituent elements. A notification unit notifies of the level of the information disclosure of the predetermined apparatus calculated by the visualization level calculation unit.

### Advantageous Effects of Invention

According to the present invention, it is possible to easily provide an appropriate apparatus according to usage of a user.

### BRIEF DESCRIPTION OF DRAWINGS

FIG. 1 is a block diagram illustrating an example of an information processing apparatus.

FIG. 2 is a diagram illustrating examples of configuration information and operation information.

FIG. 3 is a diagram illustrating an example of visualization definition information.

FIG. 4 is a diagram illustrating a generation flow of visualization definition information.

FIG. 5 is a diagram illustrating an example of calculation of a visualization level.

FIG. 6 is a flowchart illustrating visualization level information provision processing according to a first embodiment.

FIG. 7 is a block diagram illustrating an information processing apparatus according to a second embodiment.

FIG. 8 is a diagram illustrating an example of deficiency or access of elements.

FIG. 9 is a flowchart illustrating visualization level information provision processing according to the second embodiment.

FIG. 10 is a block diagram illustrating an information processing apparatus according to a third embodiment.

FIG. 11 is a diagram illustrating an example of a computer that performs an information processing program.

### DESCRIPTION OF EMBODIMENTS

An embodiment of an information processing apparatus, an information processing method, and an information processing program disclosed in the present application will be described below in detail with reference to the drawings. The information processing apparatus, the information processing method, and the information processing program disclosed in the present application are not intended to be limited by the following embodiment.

### First Embodiment

### Configuration of Information Processing Apparatus

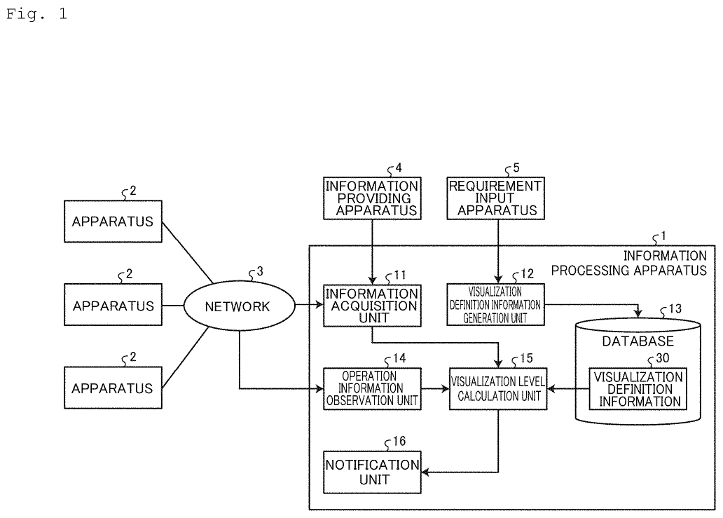

FIG. 1 is a block diagram illustrating an example of an information processing apparatus. As illustrated in FIG. 1, an information processing apparatus 1 is connected to a plurality of apparatuses 2 via a network 3. The apparatus 2 is an apparatus that is an investigation target of constituent elements. The apparatus 2 is, for example, an information processing apparatus such as a computer such as a client apparatus or a server apparatus, or a communication apparatus.

Here, the information processing apparatus 1 can generate configuration information similarly even in the single apparatus 2 or a system including the plurality of apparatuses 2. Hereinafter, an example in which configuration information of a specific apparatus 2 is generated on the assumption that a system is also included in the apparatus will be described.

In the present embodiment, a case where a user who procures the apparatus 2 uses the information processing apparatus 1 will be mainly described.

The information processing apparatus 1 is connected to an information providing apparatus 4 and a requirement input apparatus 5. The information providing apparatus 4 and the requirement input apparatus 5 are connected to each other via the network 3.

A configuration of an information processing apparatus 1 according to the first embodiment will be described with reference to FIG. 1. As illustrated in FIG. 1, the information processing apparatus 1 includes an information acquisition unit 11, a visualization definition information generation unit 12, a database 13, an operation information observation unit 14, a visualization level calculation unit 15, and a notification unit 16.

The visualization definition information generation unit 12 generates in advance visualization definition information 30 in which elements of configuration information and operation information required in each application field and a visualization level are described, and stores the visualization definition information 30 in the database 13. The visualization level is a level of information disclosure, and is an index for evaluating whether the configuration information disclosed by the provider of the apparatus 2 and the operation information obtained from the apparatus 2 are disclosed to a level sufficient for the user to perform verification or the like. Hereinafter, details of an operation of the visualization definition information generation unit 12 will be described in detail.

The visualization definition information generation unit 12 receives an input of procurement requirements, security requirements, and operation requirements necessary according to related laws, regulations, guidelines, and the like in various application fields from a requirement input apparatus 5. The application fields are not limited to major fields such as important infrastructure fields such as medical care and information communication, and a group such as an enterprise or a group may be included as one field. Here, although the procurement requirements, the security requirements, and the operation requirements are all used in the visualization definition information generation unit 12 according to the present embodiment, any one of the procurement requirements, the security requirements, and the operation requirements may be used. The security requirements may be included in the operational requirements. For example, in a representative organization or the like of a field to which the apparatus 2 is to be applied, procurement requirements, the security requirements and the operation requirements necessary according to related laws, regulations, guidelines, and the like of the field are input to the visualization definition information generation unit 12.

The procurement requirements are requirements necessary in apparatus procurement. For example, a requirement that “an apparatus of a production country shown in an entity list is not used” and the like are defined. The security requirements are requirements indicating safety required in an apparatus. For example, a requirement that “an apparatus included in a backbone network has an alteration detection function in addition to vulnerability inspection” and the like are defined. The operation requirements are requirements indicating functions required during an operation of the apparatus. For example, a requirement that “an apparatus included in a backbone network regularly perform configuration management” and the like are defined.

The visualization definition information generation unit 12 generates visualization definition information 30 for each application field in accordance with a format determined in advance based on each requirement of the procurement requirements, the security requirements, and the operation requirements. The visualization definition information 30 is, for example, information in which a visualization level required for each element included in the configuration information and the operation information necessary to satisfy the procurement requirements, the security requirements and the operation requirements are defined step by step. Each element included in the configuration information and the operation information corresponds to an item included in the configuration information and the operation information to be exemplified below.

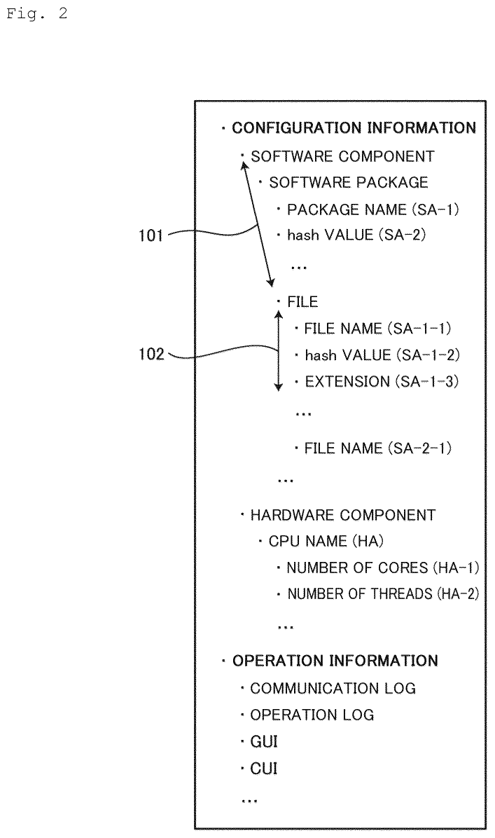

FIG. 2 is a diagram illustrating an example of the configuration information and the operation information. The configuration information includes information regarding a software component and a hardware component included in the apparatus. The operation information includes information regarding a communication log, an operation log, a graphical user interface (GUI), a character user interface (CUI), and the like and can also be called state information indicating an apparatus state. The configuration information may be hierarchically registered as illustrated in FIG. 2. Although the operation information is not hierarchized in FIG. 2, the operation information may be hierarchized.

In the following description, a depth of description for each element of the configuration information and the operation information is referred to as “depth”. In FIG. 2, an arrow 101 represents depth. That is, the depth is information indicating depth of hierarchy in which each element is located, and is expressed by, for example, the number of hierarchies. The software component includes, for example, an element of a software package. The depth of the software package is 1. In the software package, there are elements such as a package name, a hash value, and a file. The depth of each of the package name, the hash value, and the file is 2.

In the following description, a breadth of description for each element of the configuration information and the operation information is called “range”. In FIG. 2, an arrow 102 represents a range. That is, the range is information indicating the number of elements in one hierarchy below for a specific element. The range is represented by, for example, the number of elements or a ratio of the number of elements subordinate to a specific element to all the elements located in the same hierarchy. For example, in a file, there are elements such as a file name, a hash value, and an extension in one hierarchy below for each individual file. In this case, the range of the element called the file is a value according to the number of elements included in the arrow 102.

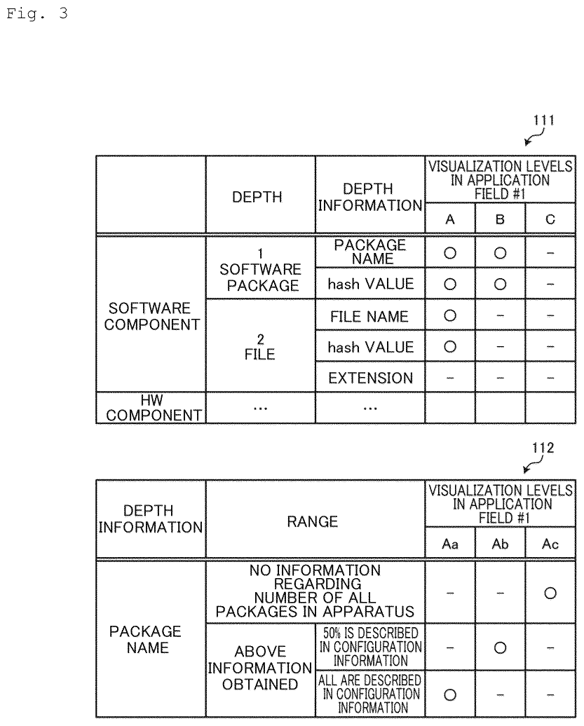

The visualization definition information 30 has a format for registering information according to the depth and the range of each element of the configuration information and the operation information. However, in the visualization definition information 30, information regarding at least one of the depth and the range may be registered. FIG. 3 is a diagram illustrating an example of the visualization definition information. The visualization definition information generation unit 12 generates, for example, the visualization definition information 30 shown in a table 111 of FIG. 3. Here, elements that are targets determined for visualization levels of the hardware component and the software component are extracted and registered as the visualization definition information 30, and the visualization levels in a certain application field were shown in three stages A to C. The visualization level A is required to be obtained from “configuration information” and “operation information” for elements of the configuration information and the operation information that enable alteration detection using the file hash. The visualization level B is required to be obtained from “configuration information” and “operation information” for elements of the configuration information and the operation information that enable configuration management and vulnerability management. The visualization level C is not required to be obtained from “configuration information” or “operation information” for elements of the configuration information and the operation information that enable alteration detection, configuration management, and vulnerability management.

For example, the visualization definition information generation unit 12 selects elements of the software package and the file as elements to be evaluated at a visualization level for software components. Then, the visualization definition information generation unit 12 registers each of the software packages in the visualization definition information 30 along with depth information. Next, the visualization definition information generation unit 12 registers a package name and a hash value as information regarding the software package in the visualization definition information 30 as depth information that is information of a visualization target obtained at the depth. The visualization definition information generation unit 12 selects a file name, a hash value, and an extension as depth information for the file as elements to be evaluated at the visualization level, and registers the file name, the hash value, and the extension in the visualization definition information 30.

Next, the visualization definition information generation unit 12 registers a visualization level required in an application field to be targeted for each piece of the registered depth information. For example, as shown in the table 111, the visualization definition information generation unit 12 defines that the package name and hash value of the software package are obtained from “configuration information” and “operation information” as the visualization level B in application field #1. Also, as shown in a table 111, for example, the visualization definition information generation unit 12 defines that the file name, the hash value, and the extension are obtained from “configuration information” and “operation information” as the visualization level A in application field #1.

The visualization definition information generation unit 12 may generate the visualization definition information 30 in which a visualization level is defined for a specific element in more detail from a viewpoint of a range. For example, the visualization definition information generation unit 12 may generate visualization definition information 30 related to a range of a package name that is one element included as depth information in the software package described in the table 111, as shown in a table 112 of FIG. 3. As shown in the table 112, the visualization definition information generation unit 12 further divides the visualization level A into three visualization levels Aa, Ab, and Ac. The table 112 is a table indicating which information is recognized as detailed visualization levels Aa, Ab and Ac when the information is obtained from “configuration information” and “operation information” for a specific element. For example, the visualization level Ab defines that, for all the package names of all software packages included in the apparatus 2, the number of all package names and 50% of the package names are obtained from “configuration information” and “operation information”. The visualization definition information generation unit 12 may incorporate the table 112 into the table 111 to generate one table.

Thereafter, the visualization definition information generation unit 12 registers the generated visualization definition information 30 for each application field in the database 13. The visualization definition information generation unit 12 is an example of an “index setting unit”, and receives at least one of the procurement requirements, the operation requirements, and the security requirements necessary for a predetermined apparatus and sets an index for evaluating a level of information disclosure for each constituent element included in the predetermined apparatus.

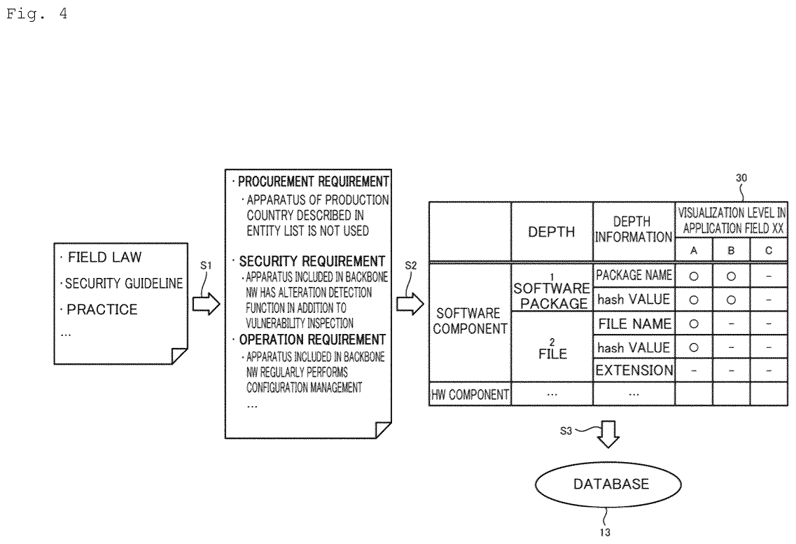

FIG. 4 is a diagram illustrating a generation flow of the visualization definition information. Here, the generation flow of the visualization definition information 30 will be described collectively again with reference to FIG. 4.

For example, a representative organization or the like of each application field generates the procurement requirements, the security requirements, and the operation requirements necessary from various guidelines, practices, and the like such as related laws, regulations, security guidelines such as laws of each field (step S1).

The visualization definition information generation unit 12 receives an input of the procurement requirements, the security requirements, and the operation requirements from the requirement input apparatus 5 or the like. Subsequently, the visualization definition information generation unit 12 generates the visualization definition information 30 for each application field based on the acquired procurement requirements, security requirement, and operation requirement (step S2).

Thereafter, the visualization definition information generation unit 12 stores each piece of the generated visualization definition information 30 for each application field in the database 13 (step S3).

Referring back to FIG. 1, description will continue. The information acquisition unit 11 acquires partial configuration information including information regarding the partial constituent elements among all the constituent elements of the apparatus 2. The partial configuration information is information permitted to be provided by a provider of the apparatus 2, and does not include information not permitted to be provided by the provider, such as confidential information of the apparatus 2 among all the constituent elements of the apparatus 2. The partial configuration information includes, for example, a component name of hardware and a software name in the apparatus 2 as constituent elements.

The information acquisition unit 11 may acquire, for example, information regarding constituent elements of the apparatus 2 transmitted by the provider of the apparatus 2 using the information providing apparatus 4. The information acquisition unit 11 may acquire information regarding constituent elements that can be acquired by the apparatus 2 via the network 3.

Alternatively, the information acquisition unit 11 may acquire information regarding constituent elements provided by the provider of the apparatus 2 to the user of the information processing apparatus 1 by an input using an input device (not illustrated) by the user. The information acquisition unit 11 can collectively use the information regarding the constituent elements of the apparatus 2 acquired by the various means as the partial configuration information.

Thereafter, the information acquisition unit 11 outputs the acquired partial configuration information to the visualization level calculation unit 15.

The operation information observation unit 14 observes an operation within a range permitted by the provider to the apparatus 2 operating in a test environment constructed by a user, and extracts operation information indicating a feature of the operation of the apparatus 2. For example, when the range permitted by the provider is capture of communication, capture of a GUI or a CUI, or the like, the operation information observation unit 14 performs the capture of communication performed by the apparatus 2, the capture of the GUI or the CUI displayed by the apparatus 2, or the like. In addition, the operation information observation unit 14 may acquire an operation log or the like if the operation log or the like is within a range permitted by the provider. Then, the operation information observation unit 14 outputs the extracted operation information of the apparatus 2 to the visualization level calculation unit 15. In this way, the operation information observation unit 14 observes an operation of the predetermined apparatus and acquires operation information indicating a feature of the operation.

The visualization level calculation unit 15 receives an input of the partial configuration information from the information acquisition unit 11. The visualization level calculation unit 15 receives an input of the operation information of the apparatus 2 from the operation information observation unit 14.

Subsequently, the visualization level calculation unit 15 receives an input of the application field of the apparatus 2. For example, the visualization level calculation unit 15 can acquire information regarding an application field input by the user using an input device (not illustrated) of the information processing apparatus 1. Then, the visualization level calculation unit 15 retrieves the database 13 based on the designated application field and acquires the visualization definition information 30 of the designated application field from the database 13.

The visualization level calculation unit 15 determines a visualization level in the designated application field for each element of the configuration information included in the acquired partial configuration information of the apparatus 2 and each element of the operation information of the apparatus 2. The visualization level calculation unit 15 calculates the visualization level of the apparatus 2 from a determination result of the visualization level of each element of the obtained configuration information and operation information.

For example, the visualization level calculation unit 15 calculates the highest visualization level among the visualization levels satisfying all the required conditions as the visualization level of the apparatus 2 in accordance with the visualization level of each element of the obtained configuration information and operation information of the apparatus 2. The visualization level calculation unit 15 may calculate a lowest visualization level among the visualization levels of the elements of the obtained configuration information and operation information of the apparatus 2 as the visualization level of the apparatus 2.

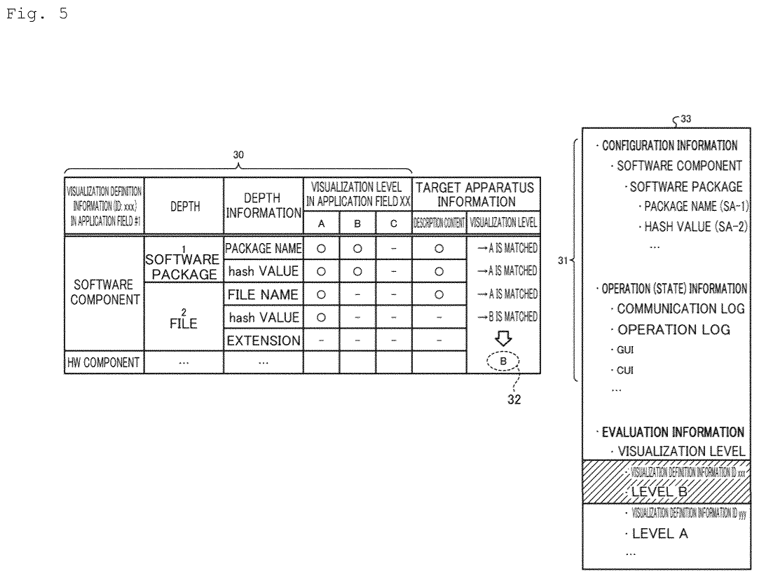

FIG. 5 is a diagram illustrating an example of calculation of the visualization levels. The visualization level calculation unit 15 calculates a visualization level of the apparatus 2 using the partial configuration information and the operation information of the apparatus 2 indicated by the acquired information 31 and the visualization definition information 30 of application field #1.

For example, the visualization level calculation unit 15 determines which visualization level is satisfied by description content of the acquired partial constituent elements with respect to the package name of the software package among elements registered in the visualization definition information 30 of application field #1. In this case, the visualization level calculation unit 15 confirms that there is the package name of the software package in the description content of the acquired partial constituent elements, and determines that the visualization level A is matched. Similarly, the visualization level calculation unit 15 confirms that there is the hash value of the software package and the file name of the file in the description content of thee acquired partial constituent elements for the hash value of the software package and the file name of the file, and determines that the visualization level A is matched. Conversely, the visualization level calculation unit 15 confirms that there is no hash value of the file in the description content of the acquired partial constituent elements for the hash value of the file, and determines that at least the visualization level B is satisfied. Then, the visualization level calculation unit 15 sets a visualization level B as the visualization level of the apparatus 2 for the hash value of the file which is the lowest visualization level, as indicated as a determination value 32.

The visualization level calculation unit 15 may generate an apparatus information file 33 of the apparatus 2 in which the determination information of the calculated visualization level of the apparatus 2 is described along with the partial configuration information and the operation information acquired by the apparatus 2. Here, as illustrated in the apparatus information file 33 of FIG. 5, when there is a plurality of designated application fields, the visualization level calculation unit 15 may calculate the visualization level of the apparatus 2 for each application field and register the visualization level in the apparatus information file 33. Further, the visualization level calculation unit 15 may highlight and display an application field which does not satisfy the visualization level required in the apparatus information file 33.

Thereafter, the visualization level calculation unit 15 outputs the generated apparatus information file of the apparatus 2 to the notification unit 16. In this way, the visualization level calculation unit 15 determines the level of the information disclosure for each constituent element included in the predetermined apparatus based on the partial configuration information, the operation information, and the index set by the index setting unit, and calculates a level of the information disclosure of the predetermined apparatus.

Here, in the present embodiment, although the visualization level of the apparatus 2 is calculated using both the partial configuration information of the apparatus 2 obtained from the information acquisition unit 11 and the operation information of the apparatus 2 observed by the operation information observation unit 14, information used to calculate the visualization level may be any one of the partial configuration and the operation information used. For example, when the operation information of the apparatus 2 is not used to calculate the visualization level, the information processing apparatus 1 may not include the operation information observation unit 14.

Referring back to FIG. 1, description will continue. The notification unit 16 receives an input of the apparatus information file of the apparatus 2 from the visualization level calculation unit 15. Then, the notification unit 16 provides the user with the apparatus information file by displaying the apparatus information file on a monitor (not illustrated). The user can confirm whether the apparatus 2 satisfies a required visualization level in an individual item by confirming the apparatus information file, and can determine procurement.

The notification unit 16 may provide the apparatus information file to the provider of the apparatus 2. Accordingly, the information of the visualization level of the apparatus 2 can be shared between users and between the users and the provider. In this way, the notification unit 16 notifies the information disclosure level of the predetermined apparatus calculated by the visualization level calculation unit 15.

### Visualization Level Calculation Processing

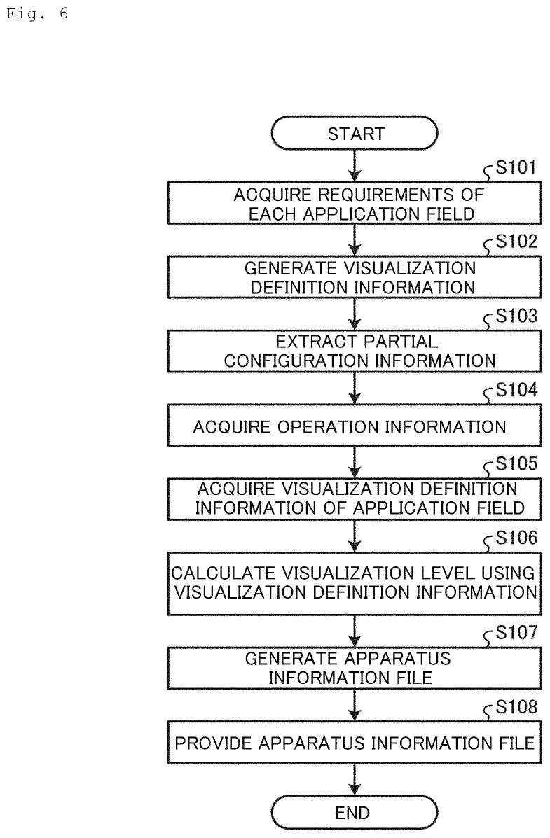

FIG. 6 is a flowchart illustrating visualization level information provision processing according to the first embodiment. Next, a flow of the visualization level information provision processing of the information processing apparatus 1 according to the first embodiment will be described with reference to FIG. 6.

The visualization definition information generation unit 12 acquires various requirements such as the procurement requirements, the security requirements, and the operation requirements necessary in related laws, regulations, guidelines, and the like in various application fields from the requirement input apparatus 5 (step S101).

Subsequently, the visualization definition information generation unit 12 generates the visualization definition information 30 for each application field based on various requirements such as the procurement requirements, the security requirements, and the operation requirements according to a format determined in advance (step S102).

The information acquisition unit 11 acquires the partial configuration information including information regarding the partial constituent elements among all the constituent elements of the apparatus 2 (step S103).

The operation information observation unit 14 observes an operation within a range permitted by the provider to the apparatus 2 operating in a test environment or the like constructed by the user, and extracts operation information that is a feature of the operation of the apparatus 2 (step S104).

The visualization level calculation unit 15 receives an input of the partial configuration information from the information acquisition unit 11. The visualization level calculation unit 15 receives an input of the operation information of the apparatus 2 from the operation information observation unit 14. Further, the visualization level calculation unit 15 receives an input of the application field of the apparatus 2 from the user. Then, the visualization level calculation unit 15 retrieves the database 13 based on the designated application field, and acquires the visualization definition information 30 of the designated application field from the database 13 (step S105).

Subsequently, the visualization level calculation unit 15 specifies a visualization level at which a condition is satisfied by the obtained information in the designated application field, for each constituent element included in the acquired partial configuration information of the apparatus 2 and each element of the operation information of the apparatus 2 with reference to the acquired visualization definition information 30. Then, the visualization level calculation unit 15 calculates a visualization level of the apparatus 2 from the visualization level of each element of the obtained configuration information and operation information (step S106).

Thereafter, the visualization level calculation unit 15 generates an apparatus information file of the apparatus 2 including the acquired partial configuration information and operation information and determination information of the visualization level of the apparatus 2 (step S107).

The notification unit 16 provides the user with the apparatus information file of the apparatus 2 generated by the visualization level calculation unit 15 (step S108).

### Effects of Classification Apparatus and Classification Processing

As described above, the information processing apparatus 1 according to the present embodiment generates the visualization definition information 30 from various requirements necessary in each application field. Then, the information processing apparatus 1 calculates the visualization level of the apparatus or the system using the partial configuration information permitted to be provided by the provider, the operation information obtained through observation, and the visualization definition information 30 of the designated application field, and provides the visualization level to the user.

In this way, by sharing the determination information of the visualization level for each application field of the apparatus or the system, the user other than the provider can confirm the visualization level for the apparatus or the system. Therefore, it is possible to determine procurement or use based on the confirmation. For example, the user can procure an apparatus or a system with a visualization level appropriate for risk countermeasures necessary in a particular application field. In addition, in an apparatus or a system requiring high-level risk countermeasures such as an important infrastructure field, the user can communicate with a provider side using the visualization level for the apparatus or the system procurement corresponding to the visualization level necessary in each field. Accordingly, the information processing apparatus 1 according to the present embodiment can facilitate provision of appropriate apparatus according to usage of the user.

### Second Embodiment

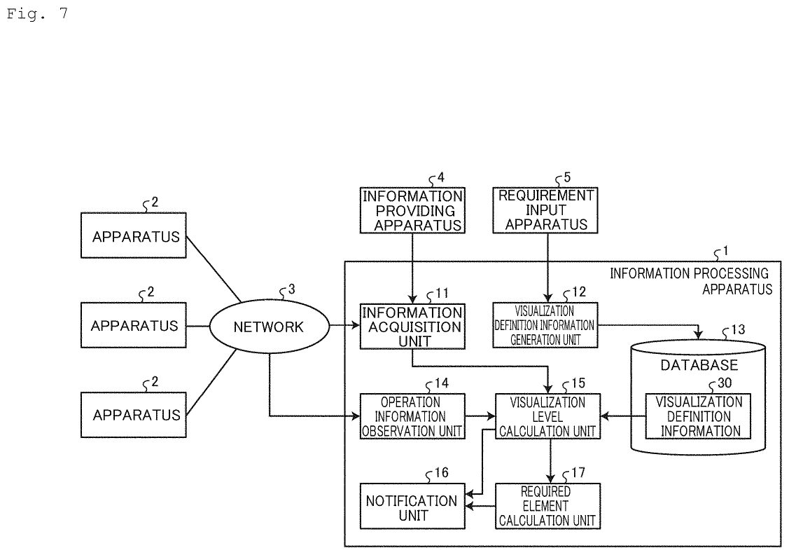

FIG. 7 is a block diagram illustrating an information processing apparatus according to a second embodiment. Next, an information processing apparatus 1 according to the second embodiment will be described with reference to FIG. 7. The information processing apparatus 1 according to the present embodiment is different from that of the first embodiment in that the information processing apparatus 1 evaluates a visualization level of the apparatus 2 and provides information regarding a change element for satisfying the visualization level requested by the user. In the present embodiment, a case where a provider who provides the apparatus 2 uses the information processing apparatus 1 will be mainly described. In the following description, an operation of each unit similar to that of the first embodiment will be omitted. The information processing apparatus 1 according to the present embodiment includes a required element calculation unit 17 in addition to each unit of the first embodiment.

The visualization level calculation unit 15 outputs the visualization definition information 30 and information regarding the visualization level of each element of the acquired partial configuration information and operation information of the apparatus 2 to the required element calculation unit 17. The visualization level calculation unit 15 outputs the generated apparatus information file of the apparatus 2 to the notification unit 16.

The required element calculation unit 17 receives an input of the visualization definition information 30 and the information regarding the visualization level of each element of the partial configuration information and the operation information of the apparatus 2 from the visualization level calculation unit 15. Subsequently, the required element calculation unit 17 compares the visualization level of each element of the partial configuration information and the operation information of the apparatus 2 with the required visualization level defined with the visualization definition information 30 and evaluates the visualization level of the apparatus 2. Then, the required element calculation unit 17 specifies a change element for the configuration information in the apparatus 2 for reaching a specific visualization level as the configuration information. For example, an additional element of the configuration information necessary to reach the level is specified based on evaluation information of the required visualization level such as use of an apparatus with the visualization level B or higher in an individual item of the application field.

In the present embodiment, the required element calculation unit 17 specifies an unnecessary element which become unnecessary if another visualization level is lower than the calculated visualization level. In addition, the required element calculation unit 17 maintains the visualization level, but may specify a replacement element which is preferable to be replaced. The replacement element is used, for example, when one of the two constituent elements is required to maintain the visualization level, when other constituent elements are required in place of one constituent element that can be gotten, or the like. In this case, the required element calculation unit 17 acquires information regarding priority of disclosure among a plurality of constituent elements which can be alternatively selected from the provider of the apparatus 2, and determines the replacement element based on the information on the priority. The replacement element may be explicitly specified by a person based on the evaluation information of the visualization level.

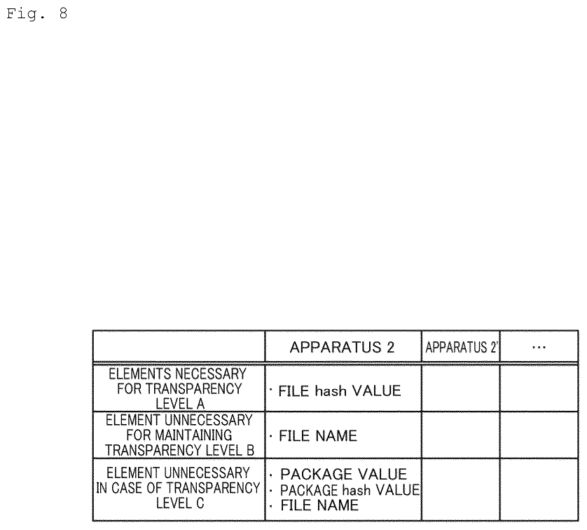

FIG. 8 is a diagram illustrating an example of deficiency or excess of elements. For example, a case where a visualization level of the apparatus 2 is B as in the description of FIG. 5 will be described. In this case, in order to set the visualization level of the apparatus 2 to A, the required element calculation unit 17 determines that the hash value of the file deficient in description content of target apparatus information, compared with the visualization level A, can be obtained as an additional element. In order to maintain a visualization level of the apparatus 2 at B, the required element calculation unit 17 determines that a file name of a file which is additionally described in the description content of the target apparatus information, compared with the visualization level B. When the visualization level of the apparatus 2 may be C, the required element calculation unit 17 determines that a package name and a package hash value of the software package and the file name of the file described in the description content of the target apparatus information are unnecessary, compared with the visualization level C.

In this way, the required element calculation unit 17 confirms the deficiency or excess of the elements, and calculates various change elements such as an additional element, an unnecessary element, replacement elements, and the like in accordance with the required visualization level.

Thereafter, the required element calculation unit 17 outputs information regarding the change element such as the additional element, the unnecessary element, and a replacement element in the designated application field corresponding to each of the visualization levels for the apparatus 2 to the notification unit 16.

The notification unit 16 receives the input of the apparatus information file of the apparatus 2 from the visualization level calculation unit 15. The notification unit 16 receives an input of information regarding the change element in the designated application field corresponding to each of the visualization levels for the apparatus 2 from the required element calculation unit 17. Then, the notification unit 16 transmits the apparatus information file to a terminal apparatus or the like of the provider of the apparatus 2, and notifies the provider of the apparatus information. The notification unit 16 transmits the information regarding the change element in the designated application field corresponding to each visualization level for the apparatus 2 to the terminal apparatus or the like of the provider of the apparatus 2, and notifies the provider of the information.

### Visualization Level Calculation Processing

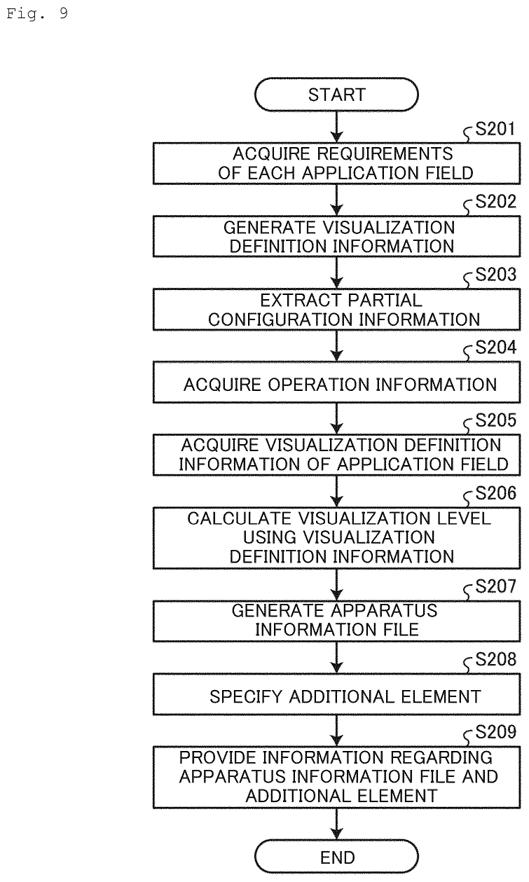

FIG. 9 is a flowchart illustrating visualization level information provision processing according to the second embodiment. Next, a flow of the visualization level information provision processing by the information processing apparatus 1 according to the second embodiment will be described with reference to FIG. 9.

The visualization definition information generation unit 12 acquires various requirements such as the procurement requirements, the security requirements, and the operation requirements necessary from the related laws, the regulations, the guidelines, and the like in various application fields from the requirement input apparatus 5 (step S201).

Subsequently, the visualization definition information generation unit 12 generates the visualization definition information 30 for each application field in accordance with a format determined in advance based on each requirement such as the procurement requirements, the security requirements, and the operation requirements, (step S202).

The information acquisition unit 11 acquires the partial configuration information including information regarding the partial constituent elements among all the constituent elements of the apparatus 2 (step S203).

The operation information observation unit 14 observes an operation within the range permitted by the provider to the apparatus 2 operating in the test environment or the like constructed by the user, and extracts the operation information which is a feature of the operation of the apparatus 2 (step S204).

The visualization level calculation unit 15 receives an input of the partial configuration information from the information acquisition unit 11. The visualization level calculation unit 15 receives an input of the operation information of the apparatus 2 from the operation information observation unit 14. Further, the visualization level calculation unit 15 receives an input of the application field of the apparatus 2. Then, the visualization level calculation unit 15 retrieves the database 13 based on the designated application field and acquires the visualization definition information 30 of the designated application field from the database 13 (step S205).

Subsequently, the visualization level calculation unit 15 specifies a visualization level to be satisfied by the acquired information regarding each constituent element included in the partial configuration information and each element of the operation information of the apparatus 2 with reference to the acquired visualization definition information 30. The visualization level calculation unit 15 determines whether each constituent element included in the partial configuration information and each element of the operation information of the apparatus 2 satisfies a visualization level required in the designated application field and determines the visualization level. Then, the visualization level calculation unit 15 calculates the visualization level of the apparatus 2 from the determination result of each element of the configuration information included in the partial configuration information and the operation information (step S206).

Thereafter, the visualization level calculation unit 15 generates the apparatus information file of the apparatus 2 including the partial configuration information, the operation information, and the determination information of the visualization level of the apparatus 2 (step S207).

The required element calculation unit 17 compares the visualization level of each element of the partial configuration information and the operation information of the apparatus 2 with the required visualization level defined in the visualization definition information 30. Then, the required element calculation unit 17 specifies the change element for the configuration information of the apparatus 2 for reaching a specific visualization level (step S208).

The notification unit 16 provides the provider of the apparatus 2 with the apparatus information file and information regarding the change element in the designated application field corresponding to each of the visualization levels of the apparatus 2 (step S209).

As described above, the information processing apparatus 1 according to the present embodiment specifies the change element such as the additional element for satisfying the visualization level required in the application field in which a user of a providing destination uses the apparatus or the system, and notifies the provider of the change element together with the apparatus information file.

Accordingly, the provider can confirm that the visualization level of the apparatus or the system does not reach a visualization level requested by the user and unnecessary information is disclosed for the visualization level requested by the user. The provider can replace information to be provided in accordance with a reference of the provider side. Further, the provider can confirm the elements of the configuration information and the operation information required to be added to reach the visualization level requested by the user, and examine addition of an element to the configuration information and the operation information provided to the user from the viewpoint of the disclosure of company's confidential information and additional cost of a company.

In this way, the provider of the apparatus or the system can confirm the visualization level requested by the user and can avoid disclosure of unnecessary configuration information. The provider can align a lineup of the apparatus or the system that has an appropriate visualization level and a cost-transferred price associated with the provision, and can examine participation in various fields. Further, even for a provider, an apparatus, or a system that has no name value, the provider can prepare an apparatus or a system at an appropriate visualization level to add the apparatus and the system to options at procurement by a user. Accordingly, the information processing apparatus 1 according to the present embodiment can facilitate provision of the appropriate apparatus according to usage of the user.

### Third Embodiment

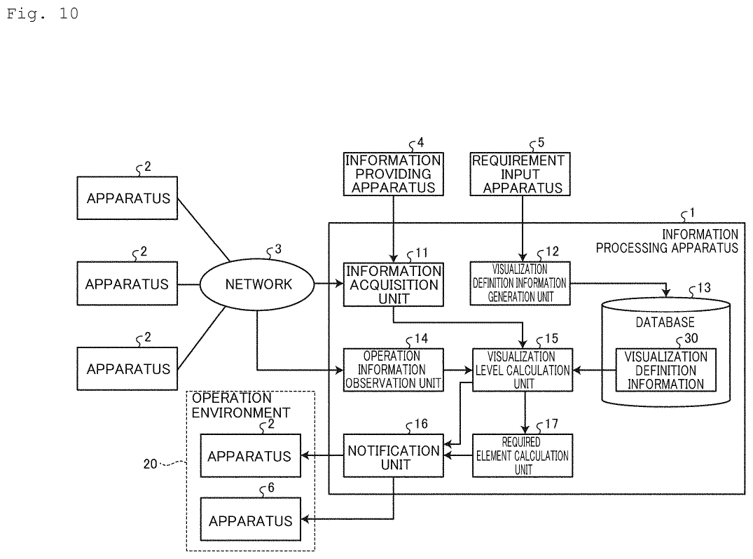

FIG. 10 is a block diagram illustrating an information processing apparatus according to a third embodiment. Next, the information processing apparatus 1 according to the third embodiment will be described with reference to FIG. 10. In the present embodiment, a case where the user replaces the apparatus 6 that has already operated in the operation environment 20 and newly introduces the apparatus 2 will be described as an example. In the present embodiment, a case in which the user uses the information processing apparatus 1 will be mainly described. In the following description, an operation of each unit similar to that of the second embodiment will be omitted.

The information processing apparatus 1 calculates the visualization level of the apparatus 2 in the visualization level calculation unit 15, and specifies an additional element for reaching the visualization level required in the required element calculation unit 17.

At the visualization level of the apparatus 2, when the visualization level of the apparatus 2 does not reach the visualization level required in the application field, the notification unit 16 confirms an additional element for reaching the required visualization level. Thereafter, the notification unit 16 determines whether information regarding an additional element is provided from the information providing apparatus 4 or the like and the visualization level of the apparatus 2 reaches the required visualization level.

While the visualization level of the apparatus 2 does not reach the required visualization level, the notification unit 16 instructs the apparatus 2 to temporarily stop the operation. The apparatus 2 temporarily stops the operation using a predetermined control application until the visualization level of the apparatus 2 reaches the required visualization level.

Further, the notification unit 16 instructs the apparatus 2 to temporarily stop the operation. The apparatus 2 instructs the apparatus 6 before replacement to operate while the visualization level of the apparatus 2 does not reach the required visualization level. The apparatus 6 continues the operation instead of the apparatus 2 until the visualization level of the apparatus 2 reaches the required visualization level.

As described above, the information processing apparatus 1 according to the present embodiment determines whether to satisfy the visualization level required in the application field for the apparatus or the system after replacement in the operation environment. When the required visualization level is not satisfied, the information processing apparatus 1 stops the operation of the apparatus or the system after replacement and continues the operation of the apparatus or system before replacement. Accordingly, the user can procure and operate the apparatus and the system that has an appropriate visualization level for the risk required in the specific application field.

### System Configuration and Like

Each constituent element of each apparatus illustrated in the drawings is functionally conceptual, and does not necessarily need to be physically configured as illustrated in the drawing. That is, specific forms of distribution and integration of the apparatuses are not limited to those illustrated in the drawings, and some or all of the forms can be distributed or integrated functionally or physically in any unit depending on various loads, usage situations, or the like. Further, some or all of the processing functions performed by the apparatuses may be realized by a central processing unit (CPU) and a program that is analyzed and executed by the CPU or may be realized as hardware using wired logic.

Of the processes described in the present embodiment, some or all of the processes described as being automatically performed can also be manually performed, or some or all of the processes described as being manually performed can also be performed automatically using a known method. In addition, the processing procedure, the control procedure, specific names, information including various types of data and parameters that are described in the above literatures and drawings may be arbitrarily changed unless otherwise mentioned.

### Program

As one embodiment, the information processing apparatus 1 can be implemented by installing an information processing program executing the above-described information processing on a desired computer as package software or online software. For example, the information processing apparatus 1 can be caused to execute the above information processing program and function. The information processing apparatus 1 mentioned here includes a desktop or a laptop personal computer. In addition, a mobile communication terminal such as a smartphone, a mobile phone, and a personal handy-phone system (PHS), and a slate terminal such as a personal digital assistant (PDA) are included in a category of the information processing apparatus 1.

The information processing apparatus 1 can also set a terminal apparatus that is used by a user as the client and can be implemented as a server apparatus that provides services related to the above information processing to the client. For example, the information processing apparatus 1 is implemented as a server apparatus which receives the partial configuration information and the operation information and provides a service for providing information of a visualization level. In this case, the server apparatus may be implemented as a Web server or as a cloud that provides services related to the above information processing by outsourcing.

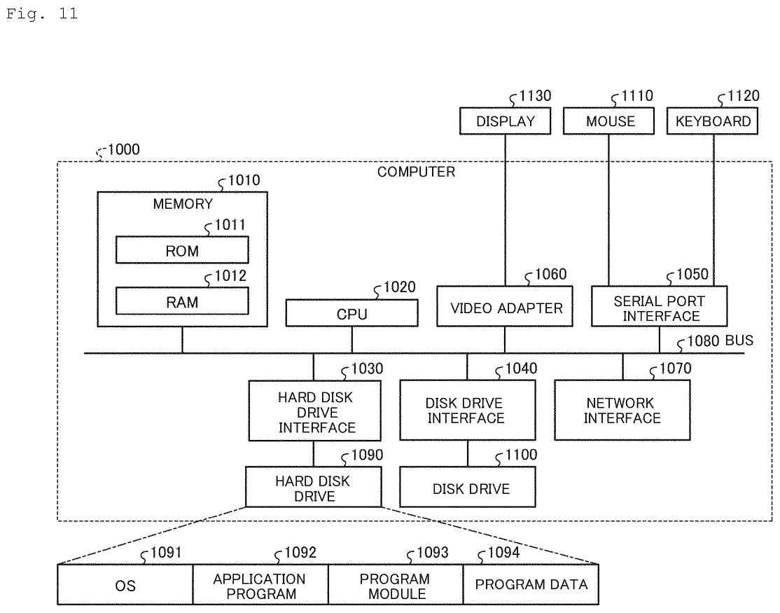

FIG. 11 is a diagram illustrating an example of a computer that executes an information processing program. A computer 1000 includes, for example, a memory 1010 and a CPU 1020. The computer 1000 also includes a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, an information processing program that defines each processing of the information processing apparatus 1 which has the same functions as those of the information processing apparatus 1 is implemented as the program module 1093 on which computer-executable codes are described. The program module 1093 is stored in, for example, the hard disk drive 1090. For example, the program module 1093 executing similar processing as the functional configuration of the information processing apparatus 1 is stored in the hard disk drive 1090. The hard disk drive 1090 may be replaced with a solid state drive (SSD).

The setting data used in the processing of the above-described embodiment is stored, for example, in the memory 1010 or the hard disk drive 1090 as the program data 1094. The CPU 1020 reads the program module 1093 or the program data 1094 stored in the memory 1010 or the hard disk drive 1090 into the RAM 1012, as necessary, and executes the processing of the above-described embodiment.

The program module 1093 and the program data 1094 are not limited to being stored in the hard disk drive 1090 and may be stored in, for example, a detachable storage medium and may be read by the CPU 1020 via the disk drive 1100 or the like. Alternatively, the program module 1093 and the program data 1094 may be stored in another computer connected via a network (a local area network (LAN), a wide area network (WAN), or the like). The program module 1093 and the program data 1094 may be read by the CPU 1020 from another computer via the network interface 1070.

### REFERENCE SIGNS LIST

1 Information processing apparatus
2 Apparatus
3 Network
4 Information providing apparatus
5 Requirement input apparatus
6 Apparatus
11 Information acquisition unit
12 Visualization definition information generation unit
13 Database
14 Operation information observation unit
15 Visualization level calculation unit
16 Notification unit
17 Required element calculation unit
20 Operation environment
30 Visualization definition Information

1. An information processing apparatus comprising:
a memory; and
processing circuitry configured to:
receive an input of at least one of a procurement requirement, an operation requirement, and a security requirement necessary for a predetermined apparatus and set an index for evaluating a level of information disclosure for each constituent element included in the predetermined apparatus;
acquire partial configuration information indicating partial constituent elements of the predetermined apparatus;
determine the level of the information disclosure for each of the constituent elements included in the predetermined apparatus based on the partial configuration information and the index set and calculate the level of the information disclosure of the predetermined apparatus based on a determination result; and
notify of the level of the information disclosure of the predetermined apparatus calculated.

2. The information processing apparatus according to claim 1,
wherein
the processing circuitry is further configured to observe an operation of the predetermined apparatus and acquire operation information indicating a feature of the operation, wherein
the processing circuitry is further configured to determine the level of the information disclosure for each of the constituent elements based on the partial configuration information, the operation information, and the index set.

3. The information processing apparatus according to claim 1,
wherein
the processing circuitry is further configured to calculate a change element for setting the level of the information disclosure of the predetermined apparatus to a predetermined level based on the partial configuration information, the index set, and the determination result of the level of the information disclosure of each of the constituent elements, wherein
the processing circuitry is further configured to notify of the change element calculated.

4. The information processing apparatus according to claim 3, wherein,
when a first apparatus is replaced with a second apparatus, the processing circuitry is further configured to stop an operation of the second apparatus until acquiring the change element of the second apparatus and causes the first apparatus to operate.

5. An information processing method by an information processing apparatus, comprising:
receiving an input of at least one of a procurement requirement, an operation requirement, and a security requirement necessary for a predetermined apparatus and setting an index for evaluating a level of information disclosure for each constituent element included in the predetermined apparatus;
acquiring partial configuration information indicating partial constituent elements of the predetermined apparatus;
determining the level of the information disclosure for each of the constituent elements included in the predetermined apparatus based on the partial configuration information and the index set and calculating the level of the information disclosure of the predetermined apparatus based on a determination result; and
notifying of the level of the information disclosure of the predetermined apparatus calculated.

6. A non-transitory computer-readable recording medium having stored therein an information processing program causing a computer to perform a process comprising:
receiving an input of at least one of a procurement requirement, an operation requirement, and a security requirement necessary for a predetermined apparatus and setting an index for evaluating a level of information disclosure for each constituent element included in the predetermined apparatus;
acquiring partial configuration information indicating partial constituent elements of the predetermined apparatus;
determining the level of the information disclosure for each of the constituent elements included in the predetermined apparatus based on the partial configuration information and the index set and calculating the level of the information disclosure of the predetermined apparatus based on a determination result; and
the level of the information disclosure of the predetermined apparatus calculated.
